(19) United States
(12) Patent Application Publication
(10) Pub. No.: US 2024/0271524 A1
(43) Pub. Date: Aug. 15, 2024

(54) Method for determining adsorbed gas content during production process of deep coalbed methane well

(71) Applicant: Exploration & Production Research Institute of SINOPEC North-China Oil & Glass Company, Zhengzhou City (CN)

(72) Inventors: Bo Hu, Zhengzhou City (CN); Yongyi Zhou, Zhengzhou City (CN); Yongming He, Zhengzhou City (CN); Kui Chen, Chengdu City (CN); Linsong Liu, Zhengzhou City (CN); Yaonan Yu, Zhengzhou City (CN); Jiawei Zhang, Zhengzhou City (CN); Shenqi Peng, Zhengzhou City (CN); Yuanxiang Sun, Zhengzhou City (CN)

(21) Appl. No.: 18/642,864

(22) Filed: Apr. 23, 2024

(30) Foreign Application Priority Data
Nov. 10, 2023 (CN) 202311494126.4

(51) Int. Cl. E21B 49/08; E21B 43/00; E21B 47/06; G01V 99/00

(52) U.S. Cl. CPC E21B 49/08; E21B 47/06; G01V 99/00; E21B 43/006

(57) ABSTRACT

A method for determining adsorbed gas content during a production process of a deep coalbed methane well, includes steps of: collecting an original formation pressure, PVT experimental analysis data, a Langmuir pressure, an adsorbed gas content in the reserves under the original formation pressure conditions, a free gas content in the reserves under the original formation pressure conditions, and a coalbed methane well productivity equation obtained based on historical production test data; establishing a functional relationship expression between the deviation factor and the formation pressure; obtaining a coalbed methane well production and a bottom hole flow pressure at a preset production time; determining a formation pressure at the preset production time; and determining a deviation factor under an original formation pressure condition; utilizing a model to determine the adsorbed gas content pₑᵣₐ in the coal bed methane production at the corresponding production time.

### CROSS REFERENCE OF RELATED APPLICATION

The present application claims priority under 35 U.S.C. 119(a-d) to CN 202311494126.4, filed Nov. 10, 2023.

### BACKGROUND OF THE PRESENT INVENTION

### Field of Invention

The present invention relates to the field of oil and gas development research, and more particularly relates to a method for determining adsorbed gas content during a production process of a deep coalbed methane well.

### Description of Related Arts

Both indoor experiments and production practice show that free gas and adsorbed gas coexist in deep coal rocks. How to determine the adsorbed gas content in the production of deep coalbed methane wells during the mining period is related to the optimization of coalbed methane development technology policies, the prediction of development indexes and the evaluation of development effects, and has very important field application value. Regarding the current method for determining the proportion of free gas and adsorbed gas in production during deep coalbed methane mining, a conventional invention with patent publication number of CN115860266A discloses a shale gas/coalbed methane well productivity evaluation method. This method establishes a target horizontal well simulation geometric model based on the well's reservoir parameters and drilling and completion parameters; constructing a set of control equations and their corresponding initial conditions and boundary conditions based on the above model, and solve the set of control equations under the constraints of the initial conditions and boundary conditions; calculating the productivity evaluation parameters of the target well during the production process; fitting the measured productivity evaluation parameters with the calculated productivity evaluation parameters, and using the key parameters and productivity evaluation parameters corresponding to the optimal fitting results as the optimal key parameters and final productivity valuation parameters for the target well in the production process, respectively. Although the invention of CN115860266A can obtain the final recoverable reserves of shale gas/coalbed methane wells, the ratio of adsorbed gas/free gas in daily gas production, fracture conductivity, matrix diffusion coefficient and adsorption capacity parameters, the entire acquisition step is complicated and difficult to promote and utilize. Therefore, it is urgent to propose a method for determining the adsorbed gas content during the production of deep coalbed methane wells.

### SUMMARY OF THE PRESENT INVENTION

The present invention provides a method for determining adsorbed gas content during a production process of a deep coalbed methane well, aiming to solve the technical problem that the existing acquisition methods are complicated and difficult to popularize.

Accordingly, in order to achieve the objects mentioned above, the present invention provides a method for determining adsorbed gas content during a production process of a deep coalbed methane well, which specifically comprises steps of:
step (1): collecting basic data of a target coalbed methane well, wherein the basic data comprises: an original formation pressure Pᵢ, PVT experimental analysis data, a Langmuir pressure P_{L}, an adsorbed gas content Gₐᵢ in the reserves under the original formation pressure conditions, and the free gas content G_{fi} in the reserves under the original formation pressure conditions, and a coalbed methane well productivity equation obtained based on historical production test data;
step (2): establishing a functional relationship expression between the deviation factor Z and the formation pressure P;
step (3): obtaining a coalbed methane well production q_{gsc} and a bottom hole flow pressure P_{wf} at a preset production time;
step (4): determining a formation pressure at the preset production time;
step (5): determining a deviation factor Zᵢ under an original formation pressure condition; according to the original formation pressure Pᵢ obtained in step (1) and utilizing a functional relationship expression between the deviation factor Z and the formation pressure P obtained in step (2): Z=f(P), and calculating the deviation factor Zᵢ=f(Pᵢ) under the original formation pressure condition;
step (6): determining a sufficiently small value of a formation pressure change amount ΔP, and based on the original formation pressure Pᵢ, the Langmuir pressure P_{L}, the adsorbed gas content Gₐᵢ in the reserves under the original formation pressure conditions, and the free gas content G_{fi} in reserves under the original formation pressure conditions collected in step (1), combined with the formation pressure P at a certain production moment determined in step (4) and the deviation factor Zᵢ under the original formation pressure conditions obtained in step (5), utilizing the model

$${p}_{era} = \frac{V 4 * ( V 5 - V 6 )}{V 1 * ( V 2 - V 3 ) + V 4 * ( V 5 - V 6 )}$$

determines the adsorbed gas content pₑᵣₐ in the coal bed methane production at a corresponding production time; wherein

$$V 1 = \frac{{G}_{fi}}{{G}_{fi} + G \text{?}} , V 2 = \frac{{Z}_{i}}{{P}_{i}} \frac{P + Δ P}{f ( P + Δ P )} , V 3 = \frac{{Z}_{i}}{{P}_{i}} \frac{P - Δ P}{f ( P - Δ P )} ,$$

$$V 4 = \frac{G \text{?}}{G \text{?} + G \text{?}} , \text{} V 5 = \frac{P + Δ P}{{P}_{i}} \times \frac{{P}_{i} + {P}_{L}}{P + Δ P + {P}_{L}} , \text{} V 6 = \frac{P - Δ P}{{P}_{i}} \times \frac{{P}_{i} + {P}_{L}}{P - Δ P + {P}_{L}} . \\ \text{?} \text{indicates text missing or illegible when filed}$$

The method for determining adsorbed gas content during the production process of the deep coalbed methane well, wherein in the step (2), the steps to establish the functional relationship expression between the deviation factor Z and the formation pressure P are as follows:
according to the PVT experimental data collected in step (1), utilizing the deviation factor as the dependent variable and the formation pressure as the independent variable, adopting a trend line function fitting in EXEL software to obtain a relational expression between the deviation factor Z and the formation pressure P: Z=f(P).

The method for determining adsorbed gas content during the production process of the deep coalbed methane well, wherein in step (3), the steps for determining the bottom hole flow pressure P_{wf} of the coalbed methane well at the preset production time are as follows:
adopting a downhole pressure gauge to directly measure the bottom hole flow pressure P_{wf} at the corresponding production time; or
based on the wellhead oil pressure, casing pressure data and gas and water production data, utilizing a preset model to determine the bottom hole flow pressure P_{wf} at the corresponding production time.

The method for determining adsorbed gas content during the production process of the deep coalbed methane well as recited in claim 1, wherein in step (4), the steps for determining the formation pressure P of the coalbed methane well at the preset production time are as follows:
according to the coalbed methane well production q_{gsc} and bottomhole flow pressure data P_{wf} obtained in step (3), utilizing the productivity equation obtained in step (1) to calculate and determine the formation pressure P at corresponding production time.

The method for determining adsorbed gas content during the production process of the deep coalbed methane well as recited in claim 1, wherein in step (6), a value of formation pressure change ΔP is less than or equal to 0.001 MPa.

### Beneficial Effects

(1) The method of the present invention is simple, easy to understand and implement, has strong operability, is effective and practical, and has good promotion and use value.

(2) The adsorbed gas content data in the production of coalbed methane wells during the mining period can be used to optimize coalbed methane development technology policies, predict development indexes, evaluate mining effects and development benefits, and has very important field application value.

These and other objectives, features, and advantages of the present invention will become apparent from the following detailed description, the accompanying drawings, and the appended claims.

### BRIEF DESCRIPTION OF THE DRAWINGS

FIG. 1 is a schematic flow chart of a method for determining adsorbed gas content during a production process of deep coalbed methane wells according to a preferred embodiment of the present invention;

FIG. 2 is a fitting diagram of a functional relationship between deviation factor and pressure.

### DETAILED DESCRIPTION OF THE PREFERRED EMBODIMENT

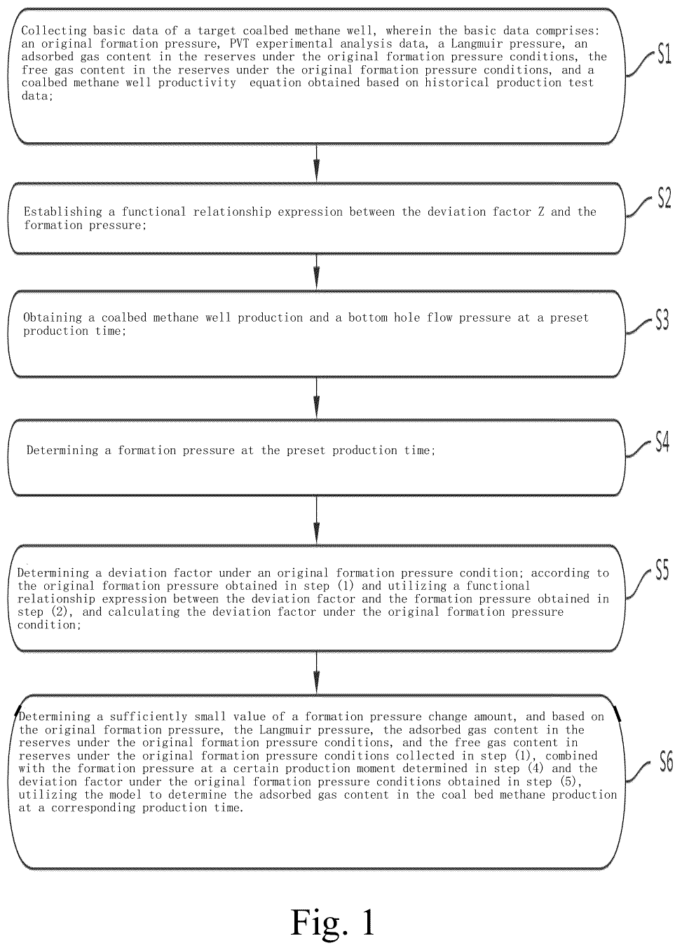

Referring to FIG. 1, the present invention provides a method for determining adsorbed gas content during a production process of a deep coalbed methane well, wherein a specific implementation method is as follows:
step (1): collecting basic data of a target coalbed methane well, wherein the basic data comprises: an original formation pressure Pᵢ, PVT experimental analysis data, a Langmuir pressure P_{L}, an adsorbed gas content Gₐᵢ in the reserves under the original formation pressure conditions, and the free gas content G_{fi} in the reserves under the original formation pressure conditions, and a coalbed methane well productivity equation obtained based on historical production test data;
step (2): establishing the functional relationship expression between the deviation factor Z and the formation pressure P; based on the PVT experimental data collected in step (1), use the deviation factor as the dependent variable and the formation pressure as the independent variable, and use the trend line function fitting in the EXEL software, the functional relationship expression between the deviation factor Z and the formation pressure P: Z=f(P) is obtained by fitting;
step (3): obtaining the coalbed methane well production q_{gsc} and bottomhole flow pressure P_{wf} at a certain production time; directly measure the bottomhole flow pressure P_{wf} at the corresponding production time through a pressure gauge; or use relevant models based on wellhead oil pressure, casing pressure data and gas and water production data to calculate and determine the bottom hole flow pressure P_{wf} at the corresponding production time;
step (4): determining the formation pressure at a certain production moment; based on the coalbed methane well production q_{gsc} and bottom hole flow pressure data P_{wf} obtained in step (3), use the productivity equation obtained in step (1) to calculate and determine the formation pressure P at the corresponding production moment;
step (5): determining the deviation factor Zᵢ under the original formation pressure condition; according to the original formation pressure Pᵢ obtained in step (1) and use the functional relationship expression Z=f(P), calculate the deviation factor Zᵢ=f(Pᵢ) under the original formation pressure condition; and
step (6): determining the value of the formation pressure change ΔP that is sufficiently small, the value of ΔP is generally required to be less than or equal to 0.001 MPa; and based on the original formation pressure Pᵢ, Langmuir pressure P_{L}, the adsorbed gas content Gₐᵢ in the reserves under the original formation pressure conditions, and the free gas content G_{fi} in reserves under the original formation pressure conditions collected in step (1), combined with the formation pressure P at a certain production moment determined in step (4) and the deviation factor Zᵢ under the original formation pressure conditions obtained in step (5), utilizing the model

$${p}_{era} = \frac{V 4 * ( V 5 - V 6 )}{V 1 * ( V 2 - V 3 ) + V 4 * ( V 5 - V 6 )}$$

to determine the adsorbed gas content pₑᵣₐ in the coal bed methane production at the corresponding production time; wherein

$$V 1 = \frac{{G}_{fi}}{{G}_{fi} + G \text{?}} , V 2 = \frac{{Z}_{i}}{{P}_{i}} \frac{P + Δ P}{f ( P + Δ P )} , V 3 = \frac{{Z}_{i}}{{P}_{i}} \frac{P - Δ P}{f ( P - Δ P )} ,$$

$$V 4 = \frac{G \text{?}}{G \text{?} + G \text{?}} , \text{} V 5 = \frac{P + Δ P}{{P}_{i}} \times \frac{{P}_{i} + {P}_{L}}{P + Δ P + {P}_{L}} , \text{} V 6 = \frac{P - Δ P}{{P}_{i}} \times \frac{{P}_{i} + {P}_{L}}{P - Δ P + {P}_{L}} . \\ \text{?} \text{indicates text missing or illegible when filed}$$

The present invention collects the original formation pressure of the target coalbed methane well, PVT experimental analysis data, Langmuir pressure, the adsorbed gas content in the reserves under the original formation pressure conditions, the free gas content in the reserves under the original formation pressure conditions, and the coalbed methane well productivity equation obtained by the previous production test data; establishing the functional relationship expression between deviation factor and formation pressure; obtaining coalbed methane well production and bottom hole flow pressure data at a certain production time; determining the formation pressure at the corresponding production time; determining the deviation factor under the original formation pressure conditions; and utilizing a model to determine the adsorbed gas content in the coalbed methane production at the corresponding production time; the method of the invention is simple, easy to understand, has strong operability, and has good promotional and practical value.

Further, in step (6), the derivation process of the determination model for adsorbed gas content in coalbed methane production is as follows:

According to the isothermal adsorption equation of coal bed methane, the adsorbed gas content V_{gi} in unit mass of coal rock under the original formation pressure Pᵢ can be obtained:

$${V}_{gi} = \frac{{V}_{L} * {P}_{i}}{{P}_{i} + {P}_{L}} ; \qquad ( 1 )$$

The adsorbed gas content in unit mass of coal rock under any formation pressure P is

$${V}_{g} = \frac{{V}_{L} * P}{P + {P}_{l}} ,$$

so the cumulative production of adsorbed gas in unit mass of coal rock under formation pressure P is Uₚₐ:

$${U}_{pa} = {V}_{gi} - {V}_{g} = \frac{{V}_{L} * {P}_{i}}{{P}_{i} + {P}_{L}} - \frac{{V}_{L} * P}{P + {P}_{L}} ; \qquad ( 2 )$$

Then the adsorbed gas recovery degree Rₐₚ corresponding to the formation pressure P is:

$${R}_{ap} = {U}_{pa} / {V}_{gi} ; \qquad ( 3 )$$

From formula (1), formula (2) and formula (3), we can get:

$${R}_{ap} = \frac{\frac{{V}_{L} * {P}_{i}}{{P}_{i} + {P}_{L}} - \frac{{V}_{L} * P}{P + {P}_{L}}}{\frac{{V}_{L} * {P}_{i}}{{P}_{i} + {P}_{L}}} = 1 - \frac{P}{{P}_{i}} \frac{{P}_{i} + {P}_{L}}{P + {P}_{L}} ; \qquad ( 4 )$$

Setting the adsorbed gas reserve under the original formation pressure and temperature conditions as G₀ₐ, then according to the adsorbed gas recovery degree Rₐₚ corresponding to the pressure P, the cumulative production of adsorbed gas Gₚₐ is:

$${G}_{pa} = {G}_{0 a} * {R}_{ap} ; \qquad ( 5 )$$

From equation (4) and equation (5), we can get:

$${G}_{pa} = {G}_{0 a} * ( 1 - \frac{P}{{P}_{i}} \frac{{P}_{i} + {P}_{L}}{P + {P}_{L}} ) ; \qquad ( 6 )$$

Presetting the free gas content in the reserves under the original formation pressure conditions in the coal rock as G_{fi}, the adsorbed gas content in the reserves under the original formation pressure conditions as Gₐᵢ, and the original reserves of the coalbed methane well as G₀, then under the original formation pressure and temperature conditions, the adsorbed gas reserve G₀ₐ is:

$${G}_{0 a} = {G}_{0} * \frac{{G}_{ai}}{{G}_{fi} + {G}_{ai}} ; \qquad ( 7 )$$

From equations (6) and (7), we can get the calculation expression for the cumulative production of adsorbed gas Gₚₐ when the formation pressure is P.

$${G}_{pa} = {G}_{0} * \frac{{G}_{ai}}{{G}_{fi} + {G}_{ai}} * ( 1 - \frac{P}{{P}_{i}} \frac{{P}_{i} + {P}_{L}}{P + {P}_{L}} ) ; \qquad ( 8 )$$

From formula (8), we can get the cumulative production of adsorbed gas Gₚₐ₁ when the formation pressure is P+ΔP:

$${G}_{pa 1} = {G}_{0} * \frac{{G}_{ai}}{{G}_{fi} + {G}_{ai}} * ( 1 - \frac{P + Δ P}{{P}_{i}} \frac{{P}_{i} + {P}_{L}}{P + Δ P + {P}_{L}} ) ; \qquad ( 9 )$$

In the same way, the cumulative production of adsorbed gas Gₚₐ₂ when the formation pressure is P−ΔP is

$${G}_{pa 2} = {G}_{0} * \frac{{G}_{ai}}{{G}_{fi} + {G}_{ai}} * ( 1 - \frac{P - Δ P}{{P}_{i}} \frac{{P}_{i} + {P}_{L}}{P - Δ P + {P}_{L}} ) ; \qquad ( 10 )$$

When the formation pressure drops from P+ΔP to P−ΔP, a cumulative production of adsorbed gas during this period ΔGₚₐ is

$$Δ {G}_{pa} = {G}_{pa 2} - {G}_{pa 1} ; \qquad ( 11 )$$

From formula (9), formula (10) and formula (11), we can get

$$Δ {G}_{pa} = {G}_{0} * \frac{{G}_{ai}}{{G}_{fi} + {G}_{ai}} * ( \frac{P + Δ P}{{P}_{i}} \frac{{P}_{i} + {P}_{L}}{P + Δ P + {P}_{L}} - \frac{P - Δ P}{{P}_{i}} \frac{{P}_{i} + {P}_{L}}{P - Δ P + {P}_{L}} ) ; \qquad ( 12 )$$

Presetting a time it takes for the formation pressure to drop from P+ΔP to P−ΔP to be T days, then the average daily production of adsorbed gas during this period q_{ga} is:

$${q}_{ga =} \frac{Δ {G}_{pa}}{τ} = \frac{{G}_{0}}{τ} * \frac{{G}_{ai}}{{G}_{fi} + {G}_{ai}} * ( \frac{P + Δ P}{{P}_{i}} \frac{{P}_{i} + {P}_{L}}{P + Δ P + {P}_{L}} - \frac{P - Δ P}{{P}_{i}} \frac{{P}_{i} + {P}_{L}}{P - Δ P + {P}_{L}} ) ; \qquad ( 13 )$$

According to the material balance equation of free gas

$$\frac{P}{Z} = ( 1 - \frac{{G}_{pf}}{{G}_{0 f}} ) \frac{{P}_{i}}{{Z}_{i}} ,$$

the free gas recovery degree R_{fp} with formation pressure P can be obtained as:

$${R}_{fp} = \frac{{G}_{pf}}{{G}_{0 f}} = 1 - \frac{{PZ}_{i}}{{P}_{i} Z} ; \qquad ( 14 )$$

In the formula, G_{0f} is the original free gas reserve, and G_{pf} is the cumulative production of free gas.

Since the cumulative production of free gas G_{pf} is equal to the original reserve of free gas G_{0f} multiplied by the recovery degree of free gas R_{fp},

$${G}_{pf} = {G}_{0 f} * {R}_{fp} ; \qquad ( 15 )$$

From formula (14) and formula (15), we can get

$${G}_{pf} = {G}_{0 f} * ( 1 - \frac{{PZ}_{i}}{{P}_{i} Z} ) ; \qquad ( 16 )$$

Since the original free gas content in the coal rock is G_{fi}, the original adsorbed gas content is Gₐᵢ, and the original reserve of the coalbed methane well is G₀, the original free gas reserve G_{0f} is:

$${G}_{0 f} = {G}_{0} * \frac{{G}_{fi}}{{G}_{fi} + {G}_{ai}} ; \qquad ( 17 )$$

According to equations (16) and (17), when the formation pressure is P, the cumulative production of free gas G_{pf} is:

$${G}_{pf} = {G}_{0} * \frac{{G}_{fi}}{{G}_{fi} + {G}_{ai}} * ( 1 - \frac{{PZ}_{i}}{{P}_{i} Z} ) ; \qquad ( 18 )$$

From equations (8) and (18), the total output of free gas and adsorbed gas Gₚ can be obtained when the formation pressure is P:

$${G}_{p} = {G}_{pf} + {G}_{pa} = {G}_{0} * \frac{{G}_{fi}}{{G}_{fi} + {G}_{ai}} * ( 1 - \frac{{PZ}_{i}}{{P}_{i} Z} ) + {G}_{0} * \frac{{G}_{ai}}{{G}_{fi} + {G}_{ai}} * ( 1 - \frac{P}{{P}_{i}} \times \frac{{P}_{i} + {P}_{L}}{P + {P}_{L}} ) ; \qquad ( 19 )$$

$${G}_{p} = {G}_{0} * \frac{{G}_{fi}}{{G}_{fi} + {G}_{ai}} * ( 1 - \frac{{PZ}_{i}}{{P}_{i} Z} ) + {G}_{0} * \frac{{G}_{ai}}{{G}_{fi} + {G}_{ai}} * ( 1 - \frac{P}{{P}_{i}} \times \frac{{P}_{i} + {P}_{L}}{P + {P}_{L}} ) ;$$

Let the functional relationship between the deviation factor and formation pressure be:

$$Z = f ( P ) ; \qquad ( 20 )$$

From equations (19) and (20), we can get the cumulative coalbed methane production Gₚ₁ when the formation pressure is P+ΔP:

$${G}_{p 1} = {G}_{0} * \frac{{G}_{fi}}{{G}_{fi} + {G}_{ai}} * ( 1 - \frac{{Z}_{i}}{{P}_{i}} \frac{P + Δ P}{f ( P + Δ P )} ) + {G}_{0} * \frac{{G}_{ai}}{{G}_{fi} + {G}_{ai}} * ( 1 - \frac{P + Δ P}{{P}_{i}} \times \frac{{P}_{i} + {P}_{L}}{P + Δ P + {P}_{L}} ) ; \qquad ( 21 )$$

In the same way, the cumulative coalbed methane production Gₚ₂ can be obtained when the formation pressure is P-JP:

$${G}_{p 2} = {G}_{0} * \frac{{G}_{fi}}{{G}_{fi} + {G}_{ai}} * ( 1 - \frac{{Z}_{i}}{{P}_{i}} \frac{P - Δ P}{f ( P - Δ P )} ) + {G}_{0} * \frac{{G}_{ai}}{{G}_{fi} + {G}_{ai}} * ( 1 - \frac{P - Δ P}{{P}_{i}} \times \frac{{P}_{i} + {P}_{L}}{P - Δ P + {P}_{L}} ) ; \qquad ( 22 )$$

When the formation pressure drops from P+ΔP to P−ΔP, the cumulative coalbed methane production ΔGp during this period is:

$$Δ {G}_{p} = {G}_{p 2} - {G}_{p 1} ; \qquad ( 23 )$$

From formula (21), formula (22) and formula (23), we can get

$$Δ {G}_{p} = {G}_{0} * \frac{{G}_{fi}}{{G}_{fi} + {G}_{ai}} * ( 1 - \frac{{Z}_{i}}{{P}_{i}} \frac{P - Δ P}{f ( P - Δ P )} - \frac{{Z}_{i}}{{P}_{i}} \frac{P - Δ P}{f ( P - Δ P )} ) + {G}_{0} * \frac{{G}_{ai}}{{G}_{fi} + {G}_{ai}} * ( 1 - \frac{P - Δ P}{{P}_{i}} \times \frac{{P}_{i} + {P}_{L}}{P - Δ P + {P}_{L}} ) - {G}_{0} * \frac{{G}_{fi}}{{G}_{fi} + {G}_{ai}} * ( 1 - \frac{{Z}_{i}}{{P}_{i}} \frac{P + Δ P}{f ( P + Δ P )} ) - {G}_{0} * \frac{{G}_{ai}}{{G}_{fi} + {G}_{ai}} * ( 1 - \frac{P + Δ P}{{P}_{i}} \times \frac{{P}_{i} + {P}_{L}}{P + Δ P + {P}_{L}} ) \qquad ( 24 )$$

$$Δ {G}_{p} = {G}_{0} * \frac{{G}_{fi}}{{G}_{fi} + {G}_{ai}} * ( \frac{{Z}_{i}}{{P}_{i}} \frac{P + Δ P}{f ( P + Δ P )} - \frac{{Z}_{i}}{{P}_{i}} \frac{P - Δ P}{f ( P - Δ P )} ) + {G}_{0} * \frac{{G}_{ai}}{{G}_{fi} + {G}_{ai}} * ( \frac{P - Δ P}{{P}_{i}} \times \frac{{P}_{i} + {P}_{L}}{P + Δ P + {P}_{L}} - \frac{P - Δ P}{{P}_{i}} \times \frac{{P}_{i} + {P}_{L}}{P - Δ P + {P}_{L}} ) ;$$

Setting a time it takes for the formation pressure to drop from P+ΔP to P−ΔP to be T days, then the average daily production of coalbed methane during this period is

$${q}_{g} = \frac{Δ {G}_{p}}{T} ,$$

that is:

$${q}_{g} = \frac{{G}_{0}}{T} * \frac{{G}_{fi}}{{G}_{fi} + {G}_{ai}} * ( \frac{{Z}_{i}}{{P}_{i}} \frac{P + Δ P}{f ( P + Δ P )} - \frac{{Z}_{i}}{{P}_{i}} \frac{P - Δ P}{f ( P - Δ P )} ) + \frac{{G}_{0}}{T} * \frac{{G}_{ai}}{{G}_{fi} + {G}_{ai}} * ( \frac{P + Δ P}{{P}_{i}} \times \frac{{P}_{i} + {P}_{L}}{P + Δ P + {P}_{L}} - \frac{P - Δ P}{{P}_{i}} \times \frac{{P}_{i} + {P}_{L}}{P - Δ P + {P}_{L}} ) \qquad ( 25 )$$

If

$$V 1 = \frac{{G}_{fi}}{{G}_{fi} + {G}_{ai}} , V 2 = \frac{{Z}_{i}}{{P}_{i}} \frac{P + Δ P}{f ( P + Δ P )} , V 3 = \frac{{Z}_{i}}{{P}_{i}} \frac{P - Δ P}{f ( P - Δ P )} , V 4 = \frac{{G}_{ai}}{{G}_{fi} + {G}_{ai}} , V 5 = \frac{P + Δ P}{{P}_{i}} \times \frac{{P}_{i} + {P}_{L}}{P + Δ P + {P}_{L}} , V 6 = \frac{P - Δ P}{{P}_{i}} \times \frac{{P}_{i} + {P}_{L}}{P - Δ P + {P}_{L}} ;$$

from formula (25) we can get

$${q}_{g} = \frac{{G}_{0}}{T} * V 1 * ( V 2 - V 3 ) + \frac{{G}_{0}}{T} * V 4 * ( V 5 - V 6 ) ; \qquad ( 26 )$$

From formula (13), we get:

$${q}_{ga} = \frac{{G}_{0}}{T} * V 4 * ( V 5 - V 6 ) ; \qquad ( 27 )$$

From equation (26) and equation (27), the adsorbed gas content pₑᵣₐ in the coalbed methane production can be obtained when the formation pressure is P:

$${p}_{era} = \frac{{q}_{ga}}{{q}_{g}} = \frac{\frac{{G}_{0}}{T} * V 4 * ( V 5 - V 6 )}{\frac{{G}_{0}}{T} * V 1 * ( V 2 - V 3 ) + \frac{{G}_{0}}{T} * V 4 * ( V 5 - V 6 )} ; \qquad ( 28 )$$

Further simplifying equation (28), we can get

$${p}_{era} = \frac{V 4 * ( V 5 - V 6 )}{V 1 * ( V 2 - V 3 ) + V 4 * ( V 5 - V 6 )} ;$$

(29);

Equation (29) is the model for determining the adsorbed gas content in the production of coalbed methane wells during production process. In the formula:
Pᵢ: original formation pressure, MPa;
G_{fi}: free gas content in reserves under original formation pressure Pᵢ, m³/t;
Gₐᵢ: adsorbed gas content in reserves under original formation pressure Pᵢ, m³/t
Zᵢ: deviation factor under the condition of original formation pressure Pᵢ, decimal;
P: formation pressure, MPa;
ΔP: sufficiently small formation pressure change, MPa;
P_{L}: Langmuir pressure, MPa;
G₀: original reserves of coalbed methane wells, 10,000 cubic meters;
T: the time it takes for the formation pressure to drop from P+ΔP to P−ΔP, days.

### Embodiment 1

Step (1): the basic data of coalbed methane wells collected are as follows: original formation pressure Pᵢ=28 MPa, PVT experimental analysis data, Langmuir pressure P_{L}=3.3212 MPa, adsorbed gas content in reserves under original formation pressure conditions Gₐᵢ=18.34 m³/t; the free gas content in the reserves under the original formation pressure condition is G_{fi}=7.66 m³/t. The binomial productivity equation of the coalbed methane well obtained based on the previous production test data is P_{R}²=Pwf²=2.7698q_{sc}+9.4022q_{sc}².

TABLE 1
Data table of the relationship between
pressure and deviation factors

| Pressure P (MPa) | Deviation factor Z (decimal) |
|---|---|
| 31 | 0.9133 |
| 28 | 0.8805 |
| 25 | 0.8716 |
| 22 | 0.8609 |
| 19 | 0.8631 |
| 16 | 0.8619 |
| 13 | 0.8715 |
| 10 | 0.8770 |
| 8.5 | 0.8843 |
| 6 | 0.9047 |
| 3 | 0.9405 |

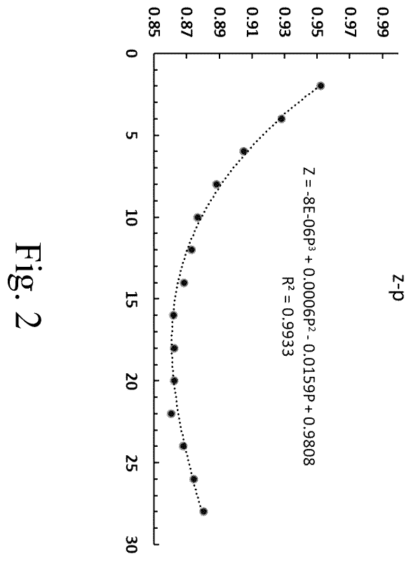

Step (2): According to the relationship between formation pressure and deviation factor in Table 1, the deviation factor calculation expression based on pressure is obtained through polynomial function fitting (see FIG. 2):

$$Z = - 8 \times {10}^{- 6} {P}^{3} + 0.0006 {P}^{2} - 0.0159 P + 0.9808 .$$

Step (3): 93 days after the coalbed methane well was put into production, the daily production was q_{gsc}=75,000 m3/day, and the bottom hole flow pressure measured by the downhole pressure gauge was P_{wf}=8.7 MPa.

Step (4): According to the coalbed methane well production rate q_{gsc}=75,000 m³/day and the bottom hole flow pressure data P_{wf}=8.7 MPa obtained in step (3), utilizing the productivity equation P_{R}²−Pwf₂=2.7698q_{sc}+9.4022q_{sc}² obtained in step (1), the formation pressure P=\sqrt{8.7*8.7+2.7698*7.5+9.4022*7.5*7.5}=25.0067 MPa at the corresponding production time is calculated.

Step (5): utilizing the deviation factor calculation expression Z=−10⁻⁶P³+0.0006P²−0.0159P+0.9808 obtained in step (2) to calculate the deviation factor Zᵢ=0.8304 corresponding to the original formation pressure Pᵢ=28 MPa.

Step (6): Setting a sufficiently small formation pressure change amount ΔP to be 0.001 MPa, that is, ΔP=0.001 MPa; based on the original formation pressure Pᵢ=28 MPa and Langmuir pressure P_{L}=3.3212 MPa, collected in step (1), the adsorbed gas content in the reserves under the original formation pressure condition is Gₐᵢ=18.34 m³/t, the free gas content in the reserves under the original formation pressure condition is G_{fi}=7.66 m³/t, combined with the formation pressure determined in step (4), P=25.0067 MPa and the deviation factor Zᵢ=0.8304 under the original formation pressure conditions obtained in step (5), the following relevant intermediate parameters can be calculated respectively,

$$V 1 = \frac{{G}_{fi}}{{G}_{fi} + {G}_{ai}} = \frac{7.66}{7.66 + 18.34} = 0.294615 ;$$

$$V 2 = \frac{{Z}_{i}}{{P}_{i}} \frac{P + Δ P}{f ( P + Δ P )} = \frac{0.8304}{28} \times \frac{25.0067 + 0.001}{\begin{matrix}- 8 \times {10}^{- 6} * {25.0077}^{3} + 0.0006 * {25.0077}^{2} - \\ 0.0159 * 25.0057 + 0.9808\end{matrix}} ;$$

$$V 2 = 0.890032 ;$$

$$V 3 = \frac{{Z}_{i}}{{P}_{i}} \frac{P - Δ P}{f ( P - Δ P )} = \frac{0.8304}{28} \times \frac{25.0067 - 0.001}{\begin{matrix}- 8 \times {10}^{- 6} * {25.0057}^{3} + 0.0006 * {25.0057}^{2} - \\ 0.0159 * 25.0057 + 0.9808\end{matrix}} ;$$

$$V 3 = 0.889958 ;$$

$$V 4 = \frac{{G}_{fi}}{{G}_{fi} + {G}_{ai}} = \frac{18.34}{7.66 + 18.34} = 0.705385 ;$$

$$V 5 = \frac{P + Δ P}{{P}_{i}} \times \frac{{P}_{i} + {P}_{L}}{P + Δ P + {P}_{L}} = \frac{25.0067 + 0.001}{28} \times \frac{28 + 3.3212}{25.0067 + 0.001 + 3.3212} = 0.987471 ;$$

$$V 6 = \frac{P - Δ P}{{P}_{i}} \times \frac{{P}_{i} + {P}_{L}}{P - Δ P + {P}_{L}} = \frac{25.0067 - 0.001}{28} \times \frac{28 + 3.3212}{25.0067 - 0.001 + 3.3212} = 0.987462 ;$$

Using the model

$${p}_{era} = \frac{V 4 * ( V 5 - V 6 )}{V 1 * ( V 2 - V 3 ) + V 4 * ( V 5 - V 6 )} ,$$

the adsorbed gas content in the output of the coalbed methane well is determined after 93 days being put into production. that is:

$${p}_{era} = \frac{0.705385 * ( 0.987471 - 0.987462 )}{\begin{matrix}0.294615 * ( 0.890032 - 0.889958 ) + \\ 0.705385 * ( 0.987471 - 0.987462 )\end{matrix}} = 0.225523 ;$$

therefore, the adsorbed gas content in the production of this gas well 93 days after it was put into production is 22.5523%, because, the daily output of the coalbed methane well at this time is 75,000 cubic meters/day, the corresponding daily output of adsorbed gas is 75,000 cubic meters/day*0.225523=16914.23 cubic meters/day. That is, after 93 days of being put into operation, the daily output of adsorbed gas of the coalbed methane well is 16914.23 cubic meters/day.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method for determining adsorbed gas content during a production process of a deep coalbed methane well, specifically comprising steps of:
step (1): collecting basic data of a target coalbed methane well, wherein the basic data comprises: an original formation pressure Pᵢ, PVT experimental analysis data, a Langmuir pressure P_{L}, an adsorbed gas content Gₐᵢ in the reserves under the original formation pressure conditions, the free gas content G_{fi} in the reserves under the original formation pressure conditions, and a coalbed methane well productivity equation obtained based on historical production test data;
step (2): establishing a functional relationship expression between the deviation factor Z and the formation pressure P;
step (3): obtaining a coalbed methane well production q_{gsc} and a bottom hole flow pressure P_{wf} at a preset production time;
step (4): determining a formation pressure at the preset production time;
step (5): determining a deviation factor Zᵢ under an original formation pressure condition; according to the original formation pressure Pᵢ obtained in step (1) and utilizing a functional relationship expression between the deviation factor Z and the formation pressure P obtained in step (2): Z=f(P), and calculating the deviation factor Zᵢ=f(Pᵢ) under the original formation pressure condition;
step (6): determining a sufficiently small value of a formation pressure change amount ΔP, and based on the original formation pressure Pᵢ, the Langmuir pressure P_{L}, the adsorbed gas content Gₐᵢ in the reserves under the original formation pressure conditions, and the free gas content G_{fi} in reserves under the original formation pressure conditions collected in step (1), combined with the formation pressure P at a certain production moment determined in step (4) and the deviation factor Zᵢ under the original formation pressure conditions obtained in step (5), utilizing the model
$${p}_{era} = \frac{V 4 * ( V 5 - V 6 )}{V 1 * ( V 2 - V 3 ) + V 4 * ( V 5 - V 6 )}$$
determines the adsorbed gas content pₑᵣₐ in the coal bed methane production at a corresponding production time; wherein
$$V 1 = \frac{{G}_{fi}}{{G}_{fi} + {G}_{ai}} , V 2 = \frac{{Z}_{i}}{{P}_{i}} \frac{P + Δ P}{f ( P + Δ P )} , V 3 = \frac{{Z}_{i}}{{P}_{i}} \frac{P - Δ P}{f ( P - Δ P )} , V 4 = \frac{{G}_{ai}}{{G}_{fi} + {G}_{ai}} , V 5 = \frac{P + Δ P}{{P}_{i}} \times \frac{{P}_{i} + {P}_{L}}{P + Δ P + {P}_{L}} , V 6 = \frac{P - Δ P}{{P}_{i}} \times \frac{{P}_{i} + {P}_{L}}{P - Δ P + {P}_{L}} .$$

2. The method for determining adsorbed gas content during the production process of the deep coalbed methane well, wherein in the step (2), the steps to establish the functional relationship expression between the deviation factor Z and the formation pressure P are as follows:
according to the PVT experimental data collected in step (1), utilizing the deviation factor as the dependent variable and the formation pressure as the independent variable, adopting a trend line function fitting in EXEL software to obtain a relational expression between the deviation factor Z and the formation pressure P: Z=f(P).

3. The method for determining adsorbed gas content during the production process of the deep coalbed methane well, wherein in step (3), the steps for determining the bottom hole flow pressure P_{wf} of the coalbed methane well at the preset production time are as follows:
adopting a downhole pressure gauge to directly measure the bottom hole flow pressure P_{wf} at the corresponding production time; or
based on the wellhead oil pressure, casing pressure data and gas and water production data, utilizing a preset model to determine the bottom hole flow pressure P_{wf} at the corresponding production time.

4. The method for determining adsorbed gas content during the production process of the deep coalbed methane well as recited in claim 1, wherein in step (4), the steps for determining the formation pressure P of the coalbed methane well at the preset production time are as follows:
according to the coalbed methane well production q_{gsc} and bottomhole flow pressure data P_{wf} obtained in step (3), utilizing the productivity equation obtained in step (1) to calculate and determine the formation pressure P at corresponding production time.

5. The method for determining adsorbed gas content during the production process of the deep coalbed methane well as recited in claim 1, wherein in step (6), a value of formation pressure change ΔP is less than or equal to 0.001 MPa.
